(19) United States
(12) Patent Application Publication
(10) Pub. No.: US 2011/0126856 A1
(43) Pub. Date: Jun. 2, 2011

(54) Method of removing contaminants from hard surfaces

(75) Inventor: Andrew F. Kegler, Ripon, WI (US)

(73) Assignee: Ergonomy LLC, Ripon, WI (US)

(21) Appl. No.: 12/589,561

(22) Filed: Oct. 26, 2009

Related U.S. Application Data
(60) Provisional application No. 61/198,071, filed on Nov. 3, 2008.

(51) Int. Cl. B08B 5/00

(52) U.S. Cl. 134/11

(57) ABSTRACT

A method for removing contaminants from hard surfaces such as metal or plastic resin material using a propane and carbon dioxide system. The propane and carbon dioxide system removes the contaminants by a varying percentage of propane to carbon dioxide to maximize the cleaning properties while creating a gas combination without a flammability range in air.

This application is based on the provisional application No. 61/198,071 filed on Nov. 3, 2008, the priority which is claimed.

### BACKGROUND OF THE INVENTION

1. Field of the Invention

The present invention relates to an improved method and system for removing contaminants from hard surface materials such as metals and plastics. More particularly, the invention relates to a single part using a system with a carbon dioxide and propane or other co-solvent mixture. The material which is cleaned is further processed in separation steps such that the clean material does not further contaminate the processing medium.

2. Description of the Prior Art

Reclamation of contaminated materials such as metals, plastics or even soil provides a highly desirable alternative to hazardous disposal of such materials. However, these materials have been expensive to properly decontaminate and often require a multiple step process or use another hazardous solvent which is subsequently cleaned in a carbon dioxide process. If the multiple stage removal process does not completely remove the first stage solvent, the material is only partially cleaned which decreases the value of the material. Further, if the materials are not sufficiently cleaned, the subsequent processing step may become contaminated by the original contaminate and/or the solvent.

Current available options to a multiple step solvent process also include a water based wash system with detergents or surfactants to solubilize the contaminants. The material will be free of contaminants however the water requires further steps to separate out the contaminants and detergents from the water. This water in itself becomes a waste material which needs to be treated accordingly.

U.S. Pat. No. 5,711,820 describes a method of separating oil from plastic contaminated with oil using liquid or supercritical carbon dioxide. However, the ability of the carbon dioxide to solvate the oil is relatively low. To be effective, the carbon dioxide must be placed under very high pressure. As a result, not only must the system equipment be designed for high pressure operations, but the utility costs in providing the high pressure carbon dioxide can also be sizeable.

There is a need for a system to remove contaminants from materials. Also, there is a need for a system which can effectively remove the contaminants at a lower pressure than carbon dioxide systems and complete the process in a single step in a safe and ecological manner which further allows subsequent steps without also contaminating those processes.

### SUMMARY OF THE INVENTION

The present invention solves the above-described problems and provides a distinct advance in the art of contaminant removal from materials. More particularly, the present invention provides a method for removing contaminants from materials using a mixture of carbon dioxide and propane or other co-solvent. The use of propane as a co-solvent, or any other liquid petroleum, at proper concentrations will form an azeotrope which allows the carbon dioxide to act as a fire retardant to the co-solvent. The mixture of carbon dioxide and co-solvent therefore provide a safe alternative to the use pure solvents. This important step allows the material to be safely cleaned prior to subsequent processing steps.

### BRIEF DESCRIPTION OF THE DRAWING

FIG. 1. Process Flow Diagram illustrating the cleaning step prior to downstream processing with recycling of the solvent used for cleaning material.

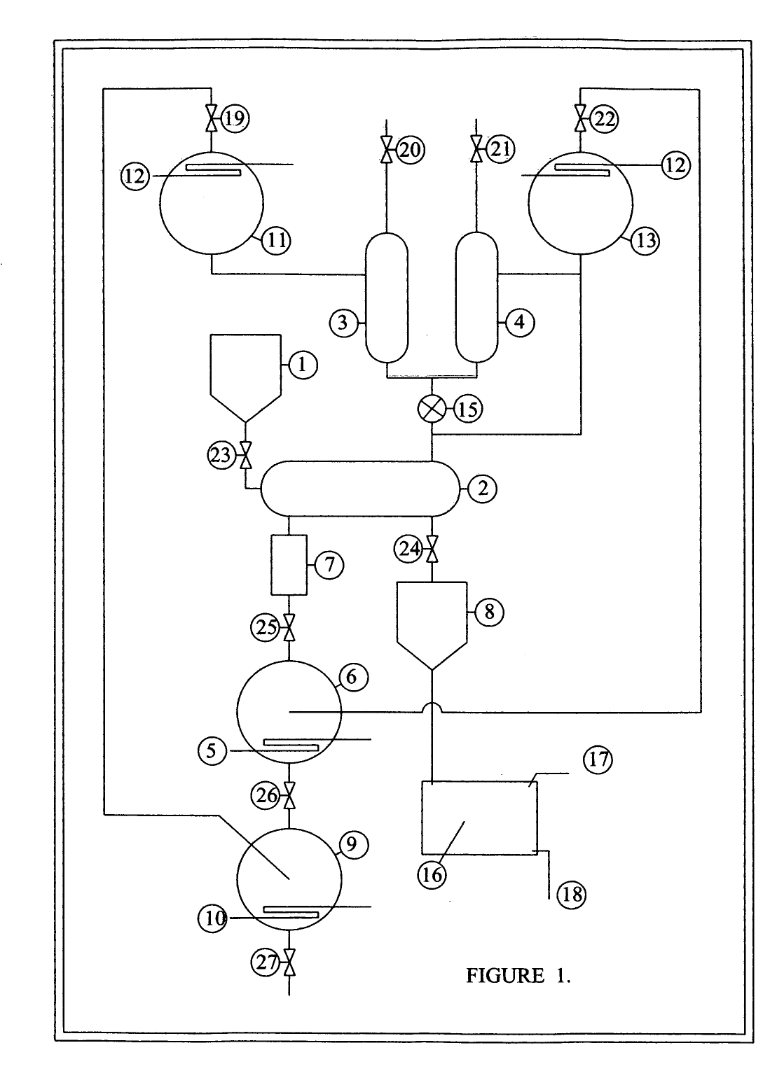

Referring now more particularly to FIG. 1, there is shown a schematic block diagram of an illustrative cleaning apparatus 2 which includes an associated pressure vessel in accordance with the present invention. As described in more detail below, the illustrative cleaning apparatus 2 utilizes liquid carbon dioxide as the cleaning solvent with a co-solvent to aid in the cleaning of complex materials. While the present invention is described in connection with liquid carbon dioxide cleaning apparatus, which has particular use in cleaning plastic, it will be readily appreciated that it is equally applicable to other types of cleaning processes which utilize a pressurized cleaning fluid or complex materials which clean better with a combination of solvents. Moreover, the present invention could also be applied in other contexts, including other systems which store pressurized fluids or gases.

The major components of the cleaning apparatus 2 include a substrate cleaning vessel having a door or valve 23 which permits incoming material access to the interior of the vessel, a carbon dioxide solvent recovery device 13, a carbon dioxide distillation vessel 6, a co-solvent recovery device, a co-solvent distillation device 11, and a downstream material separation device 16, all of which may be of conventional type. The cleaning apparatus 2 also includes a pair of storage vessels or tanks which receive and store pressurized liquid carbon dioxide and co-solvent. One of these is configured and arranged to function as a storage tank 4 for the supply of liquid carbon dioxide to the cleaning vessel 2 and the other is arranged to function as a storage tank 3 for the supply of co-solvent.

To begin the cleaning process, contaminated material such as metal or plastic or other items to be cleaned are deposited in a process vessel designed specifically to the material being cleaned such as a perforated or screened basket, an internal auger, or other such means to allow flow of carbon dioxide and co-solvent across the material to be cleaned while removing only soluble contaminants from the substrate. The inlet door or valve 23 is opened to allow the contaminated material to enter the process vessel 2. The inlet door or valve 23 to the cleaning vessel 11 is then closed and the vessel charged with liquid carbon dioxide and co=solvent from the pressurized storage tanks 3 and 4 in order to initiate the cleaning cycle. This and various other aspects of the cleaning process may be initiated and monitored through a control panel. Once charged with the liquid carbon dioxide and co-solvent, agitation may be applied to clean the items, speed up the cleaning in general, aid in the removal of any insoluble soils, and to reduce the possibility of re-deposition of contaminants. This agitation may be accomplished by flow, stirrer, internal rotating basket or any other number of methods to increase the velocity of the material in the cleaning vessel. During the wash cycles, soluble contaminants dissolve in the liquid carbon dioxide and or co-solvent. Once the wash and rinse cycles have been completed, the now decontaminated liquid carbon dioxide is drained from the cleaning vessel during a drying/draining cycle. Further rinsing of the material may be carried out by using either the carbon dioxide or co-solvent, or a combination of the two at the same or substantially different concentrations.

In order to effectively remove the contaminants from the items, the liquid carbon dioxide must be at a temperature at which the contaminants are substantially soluble. Accordingly, when liquid carbon dioxide is used, the desired pressure in the cleaning vessel 2 ranges from about 700 psi (48 bar) to about 850 psi (59 bar) while the temperature ranges from about 55 degrees F. (13 degrees C.) to about 80 degrees F. (24 degrees C.). At greater temperatures and pressures, the carbon dioxide may be in a supercritical fluidic state, and may be too aggressive for some cleaning applications on sensitive material like plastic. When the system is used to clean items other than plastics, it is desirable to allow the pressures and temperatures to increase above the supercritical range for materials which are not adversely affected by more aggressive solvent capability, such as when processing metals and contaminated earth.

For removing contaminants from the liquid carbon dioxide during the wash and rinse cycles, the liquid carbon dioxide preferably is cycled from the cleaning vessel 2 through outlet 7 to the solvent recovery device 6, which in the illustrated embodiment is configured as a still. The solvent recovery device 6 functions to vaporize the liquid carbon dioxide to separate and concentrate the co-solvent and contaminants. During such processing, the clean gaseous carbon dioxide is directed to a condenser 11 where it is re-liquefied and then returned to the storage tank 3.

For removing gaseous carbon dioxide from the cleaning vessel 11, a compressor (not shown) is provided to pump gaseous carbon dioxide from the cleaning vessel 11 to a condenser 13 where it is condensed back into liquid phase and then redirected to the storage tank 4. It will be appreciated that during the wash and rinse cycles gaseous carbon dioxide may be released from the cleaning liquid and accumulate within the cleaning vessel 11. The gaseous carbon dioxide typically is evacuated from the cleaning vessel 11 and directed to the condenser 13 during the washing and rinse cycles and upon completion of the washing operation prior to opening the cleaning vessel and removing the cleaned items. As understood by one skilled in the art, pumping gaseous carbon dioxide from the pressurized cleaning vessel 11 will reduce the internal pressure within the cleaning chamber with a resultant temperature decrease. Accordingly, an auxiliary heater may be provided in order to compensate for such temperature decrease and maintain the required temperature level within the pressurized cleaning vessel 11.

In order to control the pressure and temperature within the cleaning vessel 11, carbon dioxide may be quickly discharged from the cleaning vessel 11 to the condenser 13 through valve 22 without the need for a compressor.

In accordance with the invention, the material which has been de-contaminated is now suitable for secondary operations which may have otherwise been adversely affected or also contaminated by the substances on the material such as density separation 16 by flotation in either air or water or oil or alcohols. The list of density separation techniques are not intended to be exhaustive, but simply to illustrate the subsequent steps in material processing are now made easier since the separation medium will not be contaminated by contact with the contaminated material.

Furthermore, the contaminant which has been removed from the material is isolated from the solvents in co-solvent still 9. It is understood by anyone skilled in the art that the co-solvent still can be substantially emptied of co-solvent by applying heat through heat exchanger 10 mounted within or around still 9. This step is an important factor when isolating potentially hazardous or volatile substances from the contaminated material. By isolating the contaminant, it can be effectively removed through valve 27 in a safe manner conducive to the nature of the contaminant.

Using such a method also offers significant advantages for plastics contaminated with poly-cloryl-biphenols (PCB's) as received from automobile shredders. Plastics from automobile recycling activities are found to have levels of PCB's between 8 and 30 parts per million (ppm). When plastics are introduced to the carbon dioxide and co-solvent mixture vessel 2 for example, the PCB's are dissolved into the carbon dioxide and co-solvent mixture without damage to the plastics themselves. The PCB's are isolated in the co-solvent still 9 for safe removal. This allows the plastic to be density separated into a variety of materials types such as PP and ABS in a sink float tank 16 with a medium type such as water, brine, alcohol, air classifier or any combination thereof without further contaminating said medium. It is further understood that multiple density separation techniques may be performed in a series of steps by using multiple tanks and/or air classifiers to further density separate plastic types.

From the foregoing it can be seen that the unique method of carbon dioxide and co-solvent cleaning prior to material separation substantially reduces potential to further contaminate a subsequent step in a cleaning process.

The invention claimed is:

1. A method for removing contaminants from hard surfaces including metals and synthetic resin material comprising contacting particulate material containing at least one contaminant with a propane/carbon dioxide mixture under pressure sufficient to maintain the solvent in a liquid or supercritical state in a vessel, at least a portion of said at least one contaminant being removed from said particulate synthetic resin material and becoming dissolved in said solvent.

2. The method of claim 1 wherein said material to be de-contaminated is any hard material whether organic or inorganic and combinations thereof.

3. The method of claim 1 wherein said solvent is a mixture of carbon dioxide with propane, butane, acetylene, methanol, ethanol, paraffin, or any other liquefied petroleum gas.

4. The method of claim 1 wherein said contacting step comprises sequentially contacting said material with said solvent in one or more stages.

5. The method of claim 1 including the step of removing at least a portion of said solvent from said material.

6. The method of claim 1 wherein said material comprises particles of different densities and said contacting step includes separating the more dense materials from the less dense materials by floatation of said less dense materials in water or accelerated air or a co-solvent as described in claim 3, after decontamination of said materials.

7. A method for separating the solvent mixture of propane or other liquefied petroleum gas and carbon dioxide by distillation to separate out the dissolved contaminant from the solvent mixture.

8. The method of claim 7 wherein said solvent mixture is agitated and heated at elevated temperature and pressure to prevent fractional distillation of the solvent mixture while removing the contaminant.

9. The method of claim 7 wherein said separation of solvent mixture from the contaminant is separated in a cyclone.

10. A method of mixing carbon dioxide and propane or other liquefied petroleum gas in a manner which renders the propane or liquefied petroleum gas non-combustible in air because the proportionate mixture cannot be reduced to the necessary level to combust due to the carbon dioxide blanket which will dilute the mixture even in the event of a leak from a pressurized system.

11. The method of claim 10 wherein said mixture is between 10 to 50% propane or other liquefied petroleum gas and the balance is carbon dioxide.
